(19) United States
(12) Patent Application Publication
(10) Pub. No.: US 2013/0001379 A1
(43) Pub. Date: Jan. 3, 2013

(54) DEVICE SUPPORT SYSTEM AND METHOD

(76) Inventor: Dustin Hobbs, North Bonneville, WA (US)

(21) Appl. No.: 13/583,927

(22) PCT Filed: Mar. 8, 2011
(86) PCT No.: PCT/US11/27505

§ 371 Date: Sep. 10, 2012

Related U.S. Application Data
(60) Provisional application No. 61/311,761, filed on Mar. 8, 2010.

(51) Int. Cl. F16M 11/00

(52) U.S. Cl. 248/126

(57) ABSTRACT

A system and method are disclosed for supporting a mobile device comprising a main body including a diameter for nesting a rotating holder. The rotating holder holds the mobile device and rotates within the diameter to position the mobile device at a desired angle. A pin lock is also included in the system for engaging the rotating holder to prevent the rotating holder from rotating in a backward direction and holding the rotating holder at the desired angle.

### FIELD OF INVENTION

The present invention relates to support systems. More specifically, the present invention relates to support systems for mobile devices.

### BACKGROUND

More and more people are staying connected through mobile devices. As these products become more and more popular, manufacturers are producing different devices to accommodate the demand. This has generated numerous types of products of varying sizes in the market.

As a result of this fast increase in the product offerings for mobile devices, the need for accessories and products that can be used with these products has increased. Specifically, for mobile devices such as tablets, e.g., iPad, Nook, Kindle, etc., there has been an increase in the need for a system that makes it easier to operate the device. As such, manufacturers have designed stands that allow users to support the device up without having to hold the device in the user's hands.

Currently, stands have been designed that allow a user to view and use the device at a single angle, not allowing the angle to be adjusted, or limiting device angle adjustments to 2 or 3 positions.

For those stands that allow adjustment of the viewing angle, the pivot point is placed in the center back of the device, such that when the device is laid back, it raises the front making it unusable for typing.

Many current adjustable designs are also held tight by tension, which can be difficult to adjust, possibly damage the device, and wear out. Also, many of the adjustable designs can only be adjusted by removing the device from the stand.

Therefore, there exists a need for an improved support system for mobile devices.

### SUMMARY

A system and method are disclosed for supporting a mobile device comprising a main body including a diameter for nesting a rotating holder. The rotating holder holds the mobile device and rotates within the diameter to position the mobile device at a desired angle. A pin lock is also included in the system for engaging the rotating holder to prevent the rotating holder from rotating in a backward direction and holding the rotating holder at the desired angle.

### BRIEF DESCRIPTION OF THE DRAWINGS

FIG. 1 is an example support system 100 in accordance with a disclosed method and system;

FIG. 2 is an example illustration of a side cross-sectional view of the disclosed support system;

FIG. 3 is an example illustration of a side view of the disclosed support system;

FIG. 4 is an example illustration of a perspective view of an alternative support system;

FIG. 5 is an example illustration of a side cross-sectional view of the disclosed support system;

FIG. 6 is a more detailed illustration of the side cross-sectional view shown in FIG. 5;

FIG. 7 is an example illustration of an alternative support system including a flip support;

FIG. 8 is an example illustration of the disclosed support system having a device placed therein;

FIG. 9 is an example flow diagram of the disclosed method; and

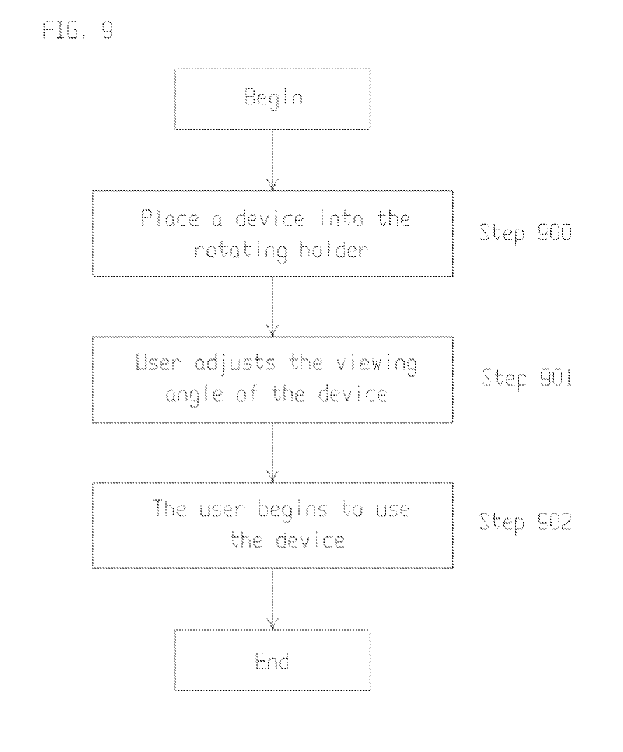

FIG. 10 is another example flow diagram of the disclosed method.

### DETAILED DESCRIPTION

When referred to hereafter, the term device may refer to user equipment, a mobile station, a fixed or mobile subscriber unit, a cellular telephone, a personal digital assistant (PDA), electronic tablet, e.g., an iPad®, Xoom™, an electronic reader, a computer, or any other type of user device capable of operating in a wireless environment, a monitor, or any other device that allows a user to view information.

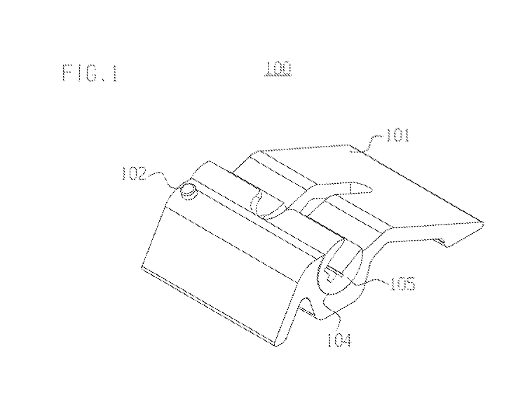

A system and method are disclosed for supporting a device, wherein the device may be used or viewed by a user at desired angle, e.g., using or reading a touch screen of the device. FIG. 1 is an example illustration of the support system 100 in accordance with the disclosed method and system. The support system 100 includes a rotating holder 105, a main body 101, and a lock pin 102. The main body 101 includes a diameter 104 In an alternative, main body 101 may further include feet 109 at the bottom of the main body that allow main body 101 to grip a horizontal surface that the support system 100 may be sitting on. The diameter 104 may be cut into the main body 101 for nesting the rotating holder 105 therein.

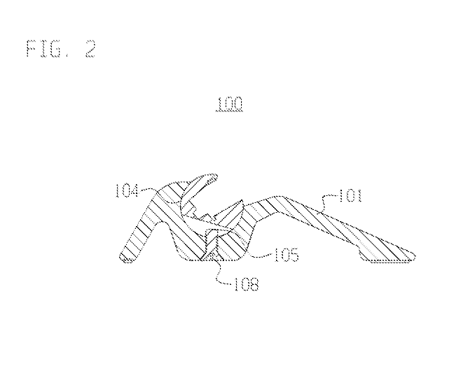

An example side cross-sectional view of the support system 100 is illustrated in FIG. 2. The diameter 104 may be a slip fit to allow rotating of the rotating holder 105. The rotating holder 105 may also be kept from sliding out of the diameter 104 using a keeper pin 108, for example a flat head cap screw. The rotating holder 105 may include a groove, wherein the keeper pin 108 fits, allowing movement of the rotating holder 105 in the forward and backward directions, to be disclosed hereinafter.

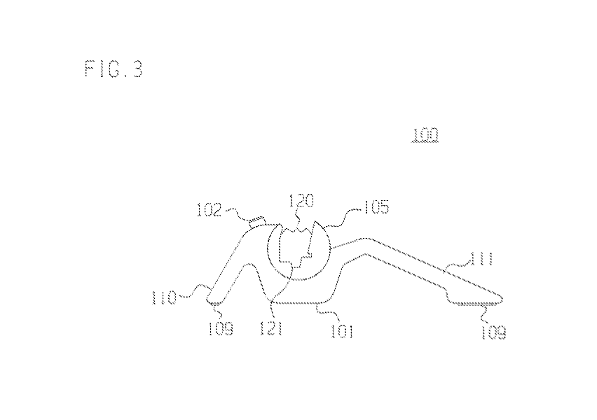

FIG. 3 illustrates an example side view of the support system 100. The rotating holder 105 may be cylindrical in shape, but may be any shape that is able to rotate within the diameter 104. The rotating holder 105 includes a concave cutout 120. The concave cutout 120 preferably may be a “u” shape, but may also be a “v” or other similar shape to accommodate and hold a variety of devices.

In an alternative, rotating holder 105 further includes a locking mechanism, not shown, that prevents a device placed within the concave cutout 120 from being removed even when the support system 100 is held upside down. In this alternative, main body 101 may further include a clipping mechanism that would allow the support system 100 to hang down, e.g., the support system 100 is able to hang from an automobile visor for use by a user while the automobile is parked.

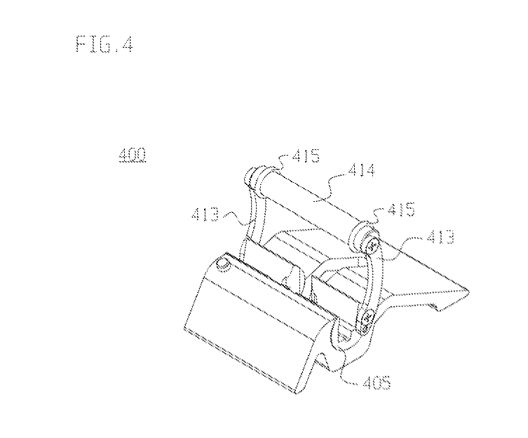

FIG. 4 is an example illustration of a perspective view of an alternative support system 400. In accordance with this alternative, support system 400 further includes support arms 413, attached to each side of the rotating holder 405, for providing additional support for a device placed with the rotating holder 405. A support bar 414, connected between support arms 413, may be further included in the supports system 405. The support bar 414 and/or the support arms 413 may include pads 415 to protect the device from being scratched and assist in preventing the device from sliding.

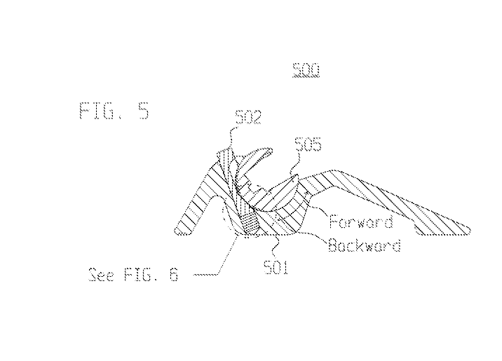

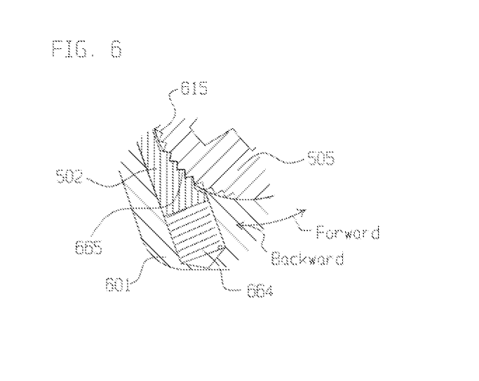

Referring back to FIG. 3, the rotating holder 105 may be prevented from rotating backward, and set to any angle using the lock pin 102. FIG. 5 is an example side cross-sectional view of system 100 illustrating the lock pin 102. FIG. 6 is an enlarged side cross-sectional view of FIG. 5. Referring to FIG. 6, the lock pin 502 may include locking teeth 665 and a spring 664. The locking teeth 665 may be at any angle and pushed in an upward direction by the spring 664.

The rotating holder 505 may include holder locking teeth 615 that may be engaged, interlocking, with pin locking teeth 665 of the lock pin 502. When the holder locking teeth 615 and locking teeth 665 are engaged, rotating holder 505 is prevented from rotating in a backward direction. The rotating holder 505 may be rotated in the forward direction when a device placed therein is pulled in the forward direction. The holder locking teeth 615, although engaged with the pin locking teeth 665, move over the pin locking teeth 665 when rotated in the forward direction. When the device is no longer pulled in the forward direction, the holder locking teeth 615 engage again with the pin locking teeth 665 to hold the device in the resulting position and angle.

As disclosed above, the pin locking teeth 665 prevent the holder locking teeth 615 from moving in the backward direction. When lock pin 502 is pushed in, spring 664 compresses, moving the pin locking teeth 665 down and disengaging the pin locking teeth 665 from the holder locking teeth 615. Once the holder locking teeth 615 are disengaged from the locking teeth 665, rotating holder 505 may be rotated in the backward direction by pushing a device held in the rotating holder 505 in the backward direction. When the rotating holder 505 is in the desired position, the lock pin 502 may be released, returning the spring 664 to its original position, pushing the pin locking teeth 665 up and automatically reengaging the pin locking teeth with the holder locking teeth 615.

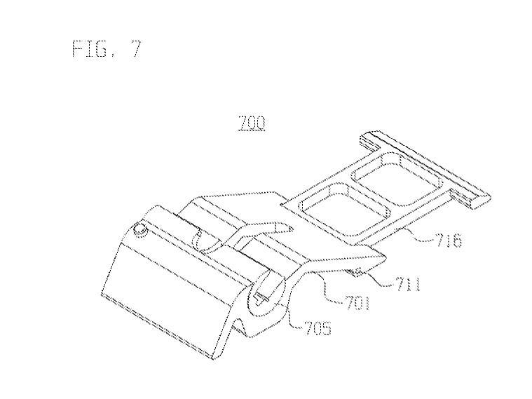

In a disclosed alternative, referring to FIG. 7, the support system 700 includes a flip support 716 to provide additional support for a device in use by a user, i.e., a user using the touch screen of a device, wherein additional pressure is applied directly to the device by the user. The flip support 716 may be held to the main body 701 by hinge pins 711. The hinge pins 711 may go into bushings, for example, that allow the flip support 716 to rotate open and closed. The bottom of the main body 701, alternatively, may allow the flip support 716 to rest therein when the flip support 716 is closed.

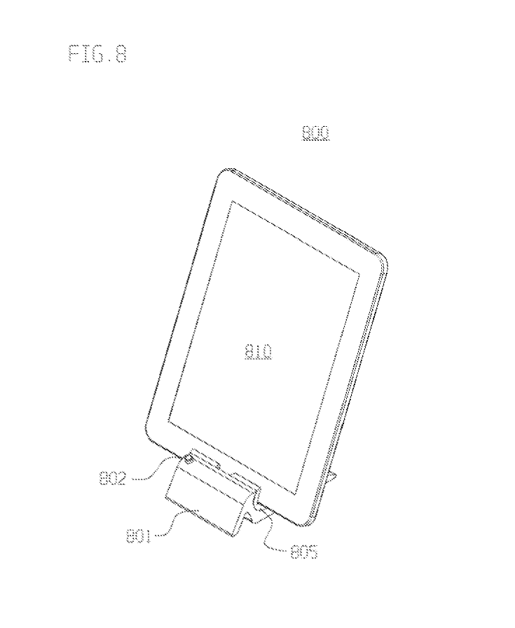

FIG. 8 is an example illustration of the support system 800 wherein a device 810 has been placed in the rotating support 805. The device 810, as shown in this example illustration, is an electronic tablet, such as an iPad or Galaxy Tab. Although a tablet is used in this example, any device may be supported by the support system 800. In accordance with a disclosed method, the device 810 is placed in the rotating support 805 by a user (Step 900). When a user wishes to adjust the viewing angle of the device 810 in the forward direction, the user pulls the device 810 forwards (Step 901). As the user pulls the device 810, the rotating support 805 rotates forwards until the device 810 reaches the position and viewing angle the user desires. Once the device 810 is at the desired angle, the user releases the device 810 and begins using the device (Step 902).

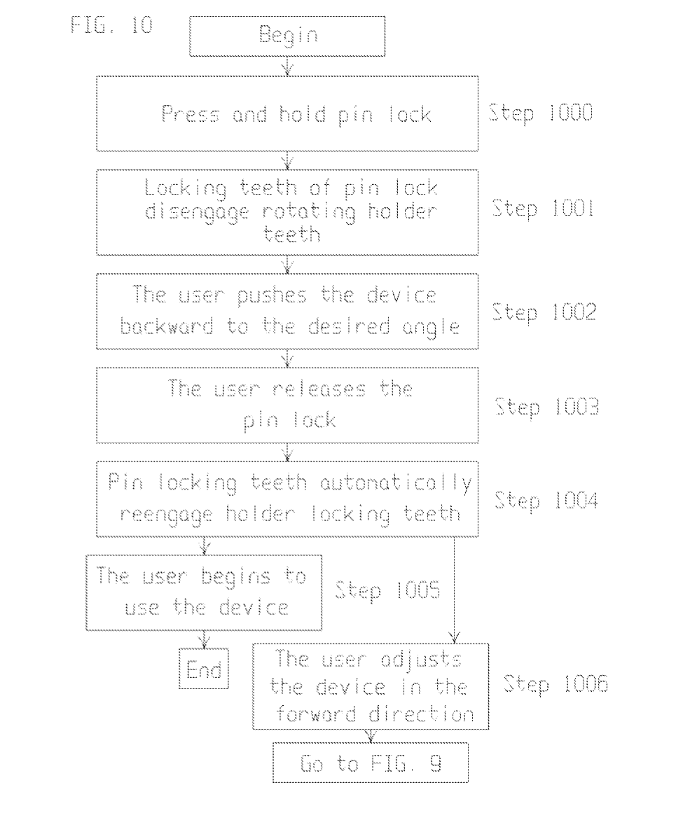

FIG. 10 is an example flow diagram of the disclosed method, wherein the user wishes to change the viewing angle of the device 810 in the backward direction. The user may press and hold the pin lock 802 (Step 1000). While holding the pin lock 802, the locking teeth of the pin lock 802 disengage the rotating support locking teeth (Step 1001), allowing the rotating support 805 may be rotated in either direction. The user, therefore, may push the device 810 backward to a new position (Step 1002), or all the way back, such that the device is in contact with main body 801. Once the user moves the device to the desired position, the user may release the pin lock (Step 1003), resulting in the reengagement of the pin lock 802 locking teeth with the rotating holder 805 locking teeth. (Step 1004) The user may begin to use the device in the new position (Step 1005), or pull the device to another position in the forward direction, as disclosed above (Step 1006).

Although the features and elements are described in particular combinations, each feature or element can be used alone without the other features and elements or in various combinations with or without other features and elements.

Although the support system and method have been disclosed by means of specific example, numerous modifications and variations could be made thereto by those skilled in the art without departing from the scope and spirit of the system and method set forth in the claims.

What is claimed is:

1. A support system for supporting a mobile device comprising:
a main body including a diameter for nesting a rotating holder;
the rotating holder for holding the mobile device and rotating within the diameter to position the mobile device at a desired angle; and
a pin lock for engaging the rotating holder to prevent the rotating holder from rotating in a backward direction and holding the rotating holder at the desired angle.

2. The support system of claim 1, wherein
the rotating holder includes holder locking teeth;
the pin lock includes locking teeth for engaging the holder, wherein the pin locking teeth are shaped similar to the holder teeth, such that the holder locking teeth are able to automatically disengage the pin locking teeth when rotating in the forward direction, and reengage the pin locking teeth when the desired angle is reached.

3. The support system of claim 2, wherein the holder locking teeth disengage the pin locking teeth when the pin lock is pressed, allowing the rotating holder to rotate in the backward direction.

4. The support system of claim 3, wherein the pin lock further includes a spring for automatically reengaging the locking teeth with the holder teeth when the pin lock is released.

5. The support system of claim 4 further comprising a keeper pin for preventing the rotating holder from sliding out of the diameter.

6. The support system of claim 4 further comprising one or more support arms, connected to the rotating holder, for providing additional support for the device.

7. The support system of claim 4 further comprising a flip support, attached to the main body, for providing additional support to the main body and preventing the support system from flipping over.

8. A method for adjusting a viewing angle of a device in a support system comprising:
pulling the device in a first direction until a desired viewing angle is reached; such that a rotating holder, holding the device in the support system, is engaged with a pin lock to prevent the device from rotating in a second direction; and
maintaining the desired viewing angle when the device is no longer pulled in the the first direction.

9. The method of claim 8 further comprising:
disengaging the rotating holder from the pin lock when the desired viewing angle requires the device to move in the second direction;
pushing the device in the second direction until the desired viewing angle is reached; and
reengaging the rotating holder with the pin lock to prevent the device from rotating in the second direction.

10. The method of claim 9, wherein disengaging the rotating holder includes pressing the pin lock down; and
wherein reengaging the rotating holder includes releasing the pin lock.

11. The method of claim 10, wherein engaging the rotating holder with the pin lock includes rotating holder locking teeth similar to pin locking teeth interlocking to prevent the rotating holder moving in the second direction.

12. The method of claim 11, wherein disengaging the rotating holder includes moving the pin locking teeth down when the pin lock is pressed, such that the pin locking teeth are no longer interlocking with the rotating holder locking teeth.

13. The method of claim 11, wherein the desired viewing angle is maintained when the pin locking teeth are interlocked with the rotating holder locking teeth.
